(19) United States
(12) Patent Application Publication
(10) Pub. No.: US 2020/0301761 A1
(43) Pub. Date: Sep. 24, 2020

(54) COGNITIVE APPLICATION PROGRAMMING INTERFACE DISCOVERY FROM LEGACY SYSTEM CODE

(71) Applicant: International Business Machines Corporation, Armonk, NY (US)

(72) Inventors: HARISH BHARTI, Pune (IN); Rakesh Shinde, Pune (IN); SRINIVAS G. KULKARNI, Pune (IN); RAJESH KUMAR SAXENA, Maharashtra (IN)

(73) Assignee: International Business Machines Corporation, Armonk, NY (US)

(21) Appl. No.: 16/358,777

(22) Filed: Mar. 20, 2019

(51) Int. Cl. G06F 9/54; G06F 8/75; G06F 8/20

(52) U.S. Cl. CPC G06F 9/54; G06F 8/24; G06F 8/75

(57) ABSTRACT

Application programming interface (API) discovery includes receiving source code associated with a computer system, and analyzing the source code to generate domain specific language (DSL) represented within the source code. The DSL is mapped to terms of reference associated with an enterprise, and at least one candidate API is identified based upon the terms of reference. The at last one candidate API is mapped to a portion of the source code. One or more patterns are identified between terms in the portion of source code. A source code component of the source code representative of a separate functional component within the source code is identified based upon the one or more patterns. The source code component is mapped to an enabling API.

### TECHNICAL FIELD

The present invention relates generally to a method, system, and computer program product for application programming interface (API) discovery from legacy system code. More particularly, the present invention relates to a method, system, and computer program product for cognitive application programming interface discovery from legacy system code, and identifying specific code segments from the legacy system code that is required to realize discovered APIs.

### BACKGROUND

An application programming interface (API) is a set of subroutine definitions and communication protocols for communication between software components used for building software applications. An API specification often includes specifications for routines, data structures, object classes, variables, or remote calls for interaction and communication between software components. An API often acts as a software intermediary between two software components. When developers create new application program code, they often use APIs to allow interface with sections of existing code to allow reuse of the functionality provided by the sections of existing code within the new application program code. Accordingly, efficiency and speed of development of new applications can be greatly increased.

### SUMMARY

The illustrative embodiments provide a method, system, and computer program product. An embodiment of a method for application programming interface discovery includes receiving source code associated with a computer system, and analyzing the source code to generate domain specific language (DSL) represented within the source code. The method further includes mapping the DSL to terms of reference associated with an enterprise, and identifying at least one candidate application programming interface (API) based upon the terms of reference. The embodiment further includes mapping the at last one candidate API to a portion of the source code, and identifying one or more patterns between terms in the portion of source code. The embodiment further includes identifying a source code component of the source code representative of a separate functional component within the source code based upon the one or more patterns, and mapping the source code component to an enabling API. Thus, the embodiment provides for improved linking of APIs to sections of code to allow reuse of existing code.

Another embodiment further includes receiving a user interaction input including information associated with user interaction with an application associated with the source code indicative of the function of the source code, the DSL being generated based upon the source code and user interaction input. Thus, the embodiment provides for improved generation of DSL based upon user interaction input information.

In another embodiment, the DSL is mapped to the terms of reference using natural language processing. In another embodiment, mapping the at last one candidate API to the portion of the source code includes identify the portion of the source code as indicative of a function associated with the at least one candidate API.

In another embodiment, the terms include one or more of program code logic within the source code, a program variable within the source code, or a DSL object within the source code.

In another embodiment, the one or more patterns between terms are identified using a pattern discovery model. In another embodiment, the pattern discovery model includes a cognitive model. Thus, the embodiment provides for improved determination of source code components using a cognitive model.

Another embodiment further includes determining a cohesiveness parameter between a set of the one or more patterns, and determining a relevance parameter between the set of the one or more patterns. In another embodiment, identifying the source code component is based upon the cohesiveness parameter and the relevance parameter.

In another embodiment, the cohesiveness parameter is indicative of a frequency of the set of patterns being found in training data. In another embodiment, the relevance parameter is indicative of a relevance of the set of patterns for performing a function associated with the API candidate.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for cognitive application programming interface discovery from legacy system code in accordance with an illustrative embodiment;

FIG. 4 depicts a simplified example sequence in accordance with an illustrative embodiment;

FIG. 5 depicts an example pattern taxonomy tree-like structure in accordance with an illustrative embodiment; and

FIG. 6 depicts a flowchart of an example process for cognitive application programming interface discovery from legacy system code in accordance with an illustrative embodiment.

### DETAILED DESCRIPTION

The illustrative embodiments described herein are directed to cognitive application programming interface (API) discovery from legacy system code. One or more embodiments provide for cognitive application programming interface discovery from legacy system code by combining code analytics on legacy application program source code with domain specific language (DSL) and terms of reference (ToR) to discover APIs and map the APIs to particular sections of source code.

The increased focus on using APIs (e.g., RESTful APIs) as system access mechanisms has created a requirement to API-enable existing information technology (IT) legacy systems, especially at the enterprise scale. A RESTful API is an API that uses HTTP requests to obtain data and is based on a representational state transfer (REST) technology. A legacy system includes an older method, technology, computer system, or application program that may be outdated or in need of replacement, but is still in use by the enterprise. Many enterprises struggle to discovery and identify APIs from their legacy systems since identifying modular functions and functional boundaries in legacy technologies is often a very challenging exercise.

Creating API for legacy IT systems requires a very good understanding of the legacy systems, the legacy systems functions, and the programmatic nature of the invocation of the functions. Very few enterprises possess this level of insight of their legacy systems. Further, legacy IT systems are often not well documented and have a tendency to become polymorphic, making it difficult to identify a programmatic interface and modular functions. For example, a core banking system might have evolved over a period of time and may contain several programs with overlapping functionalities or ill-defined functional boundaries.

Current procedures for API enablement or “APIfication” of legacy systems heavily rely on manual analysis and identification of relevant source files and sections of source files where functionality of a candidate API is implemented. Organizations are often not willing to invest in complete transformation or rewriting of functions but want to leverage existing legacy systems with API enablement. Existing procedures require tedious manual analysis of code to identify APIs while relying heavily on certain best practices, but such procedures are ineffective and time-consuming. Further, existing approaches often miss key business logic hidden in code as legacy code flow may not be easily understood. For example, existing legacy code may include “spaghetti” traversals and patchwork on the legacy code over several years.

In embodiments described herein, domain specific language (DSL) refers to computer language specialized to a particular application domain. A domain specific language (DSL) is created to solve problems in a particular domain in contrast to general-purpose languages that are created to solve problems in many domains. In embodiments described herein, terms of reference (ToR) refer to an industry model defining best practices for particular business requirements of an industry or enterprise such as service interface definitions, data types, and business items associated with a particular business purpose. An example of a ToR is an information framework (IFW) populated with a set of banking specific business models describing banking data content to address specific areas, process models, and integration models. An example of a domain includes a specific business area such as billing, accounting, or payroll management. One or more embodiments utilize a machine learning model to map identified APIs to a section of a codebase including source code and associated variables.

In an embodiment, a code analytics tool analyzes legacy source code to present a structure and flow of execution for inputs into API analytics using domain specific language and terms of reference. In the embodiment, the code analytics output is combined with user interaction inputs to generate domain specific language (DSL). In the embodiment, the DSL is mapped to terms of reference/industry models (e.g., IFW or Banking Industry Architecture Network (BIAN) for the banking industry, or Business Process Framework (eTOM) for the telecommunications industry) using natural language classification or another suitable artificial intelligence/machine learning process.

In the embodiment, an application identifies and maps API candidates to the existing source code based upon the ToR. In the embodiment, the application uses the identified API candidates to identify specific sections of code which include logic and variables, and the application uses a pattern discovery model to identify patterns between terms, DSL objects, and code constructs. In particular embodiments, the application uses the above procedures to train a cognitive model for a specific organization.

In the embodiment, the application applies the cognitive model to construct cohesive sets of ToR, business activity, and sections of codebase, and links them together to provide the key business function. In the embodiment, the application further builds a pattern mapping and employs machine learning to present precise mapping of identified APIs to respective sections of source code for logic and data variables.

One or more embodiments may improve the operation of a computer implementing legacy code by providing for linking of APIs to sections of code to allow reuse of the existing legacy code. One or more embodiments may utilize the described method for API discovery, identification, specification and mapping to provide API enablement of legacy systems as well as reduce time spent on application development for such legacy systems.

An embodiment can be implemented as a software application. The application implementing an embodiment can be configured as a modification of an existing code analysis system or platform, as a separate application that operates in conjunction with an existing code analysis system or platform, a standalone application, or some combination thereof.

The illustrative embodiments are described with respect to certain types of tools and platforms, procedures and algorithms, services, devices, data processing systems, environments, components, DSL objects, ToR, code analytics, APIs, cognitive models, machine learning processes, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

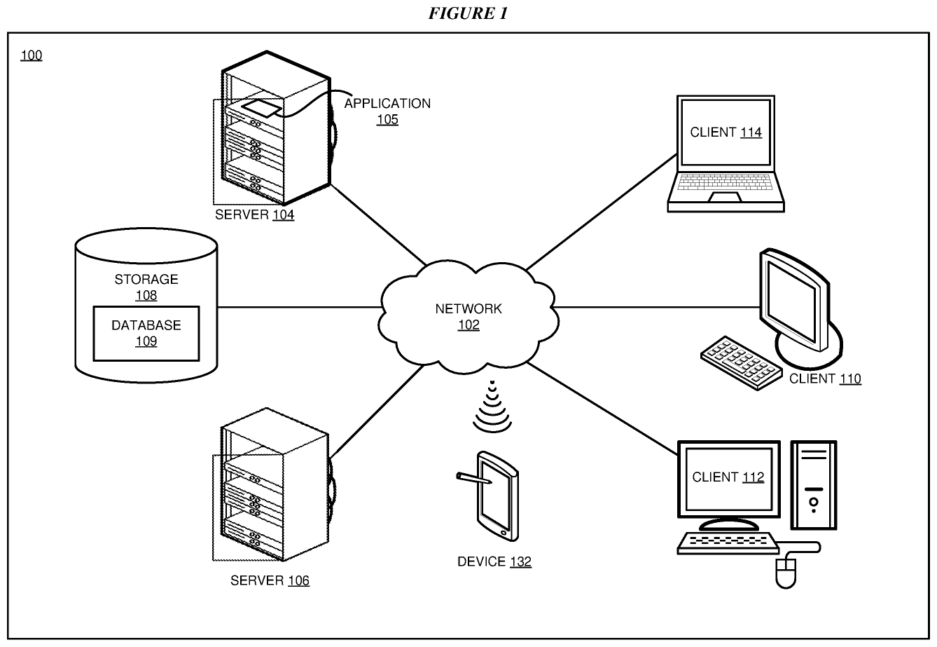

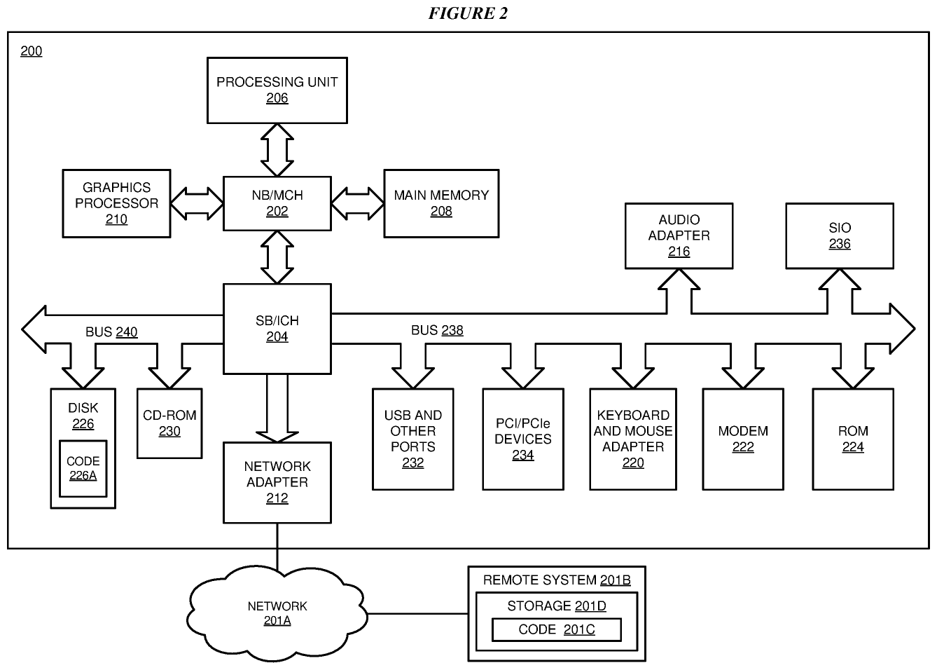

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown. Server 104 includes an application 105 that may be configured to implement one or more of the functions described herein for cognitive application programming interface discovery from legacy system code in accordance with one or more embodiments. Storage device 108 includes one or more databases 109 configured to store data such as program source code and/or cognitive model training data as described herein.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

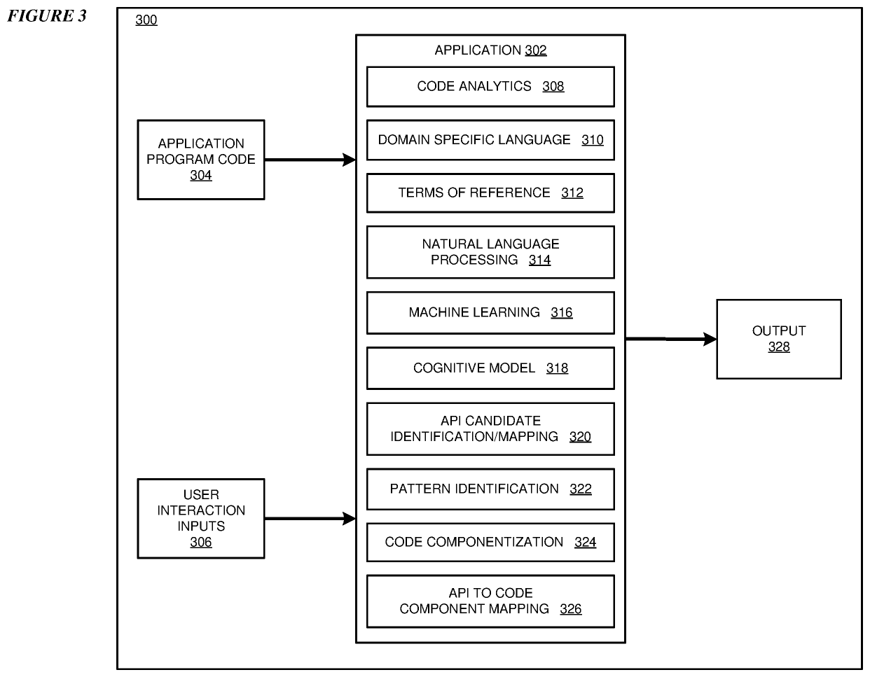

With reference to FIG. 3, this figure depicts a block diagram of an example configuration 300 for cognitive application programming interface discovery from legacy system code in accordance with an illustrative embodiment. The example embodiment includes an application 302. In a particular embodiment, application 302 is an example of application 105 of FIG. 1.

Application 302 receives application program code 304 and user interaction inputs 306. Applicant program code 304 includes source code associated with a legacy system for which API discovery is desired to be performed. User interaction inputs 306 include information associated with user interaction with an application associated with the source code that may be indicative of a function of a portion of the source code. Application 302 includes a code analytics component 308, domain specific language 310, terms of reference 312, a natural language processing component 314, a machine learning component 316, a cognitive model 318, an API candidate identification/mapping component 320, a pattern identification component 322, a code componentization component 324, and an API to code component mapping component 326.

In the embodiment, code analytics component 308 analyzes application program code 304 and user interaction inputs 306 to generate domain specific language 310 and terms of reference. In the embodiment, the code analytics output is combined with user interaction inputs to generate domain specific language (DSL) 310. In the embodiment, application 302 maps DSL 310 to terms of reference 312. using natural language processing 314 component. In the embodiment, API candidate/identification mapping component 320 identifies API candidates within application program code 304 and maps the API candidates to particular sections of application program code 304 based upon terms of reference 312.

In the embodiment, pattern identification component 322 identifies patterns between terms, DSL objects, and ToRs in application program code 304. In the embodiment, code componentization component 324 is configured to determine cohesiveness and relevance of the identified patterns and determine components of application program code 304 that represent a separate functional component (e.g., a portion of application program code 304 that is used to perform a particular function or calculation on input data). In the embodiment, API to code component mapping component maps the source code components to one or more API using machine learning component 316 based upon cognitive model 318 to generate an output 328 including the API to component mapping.

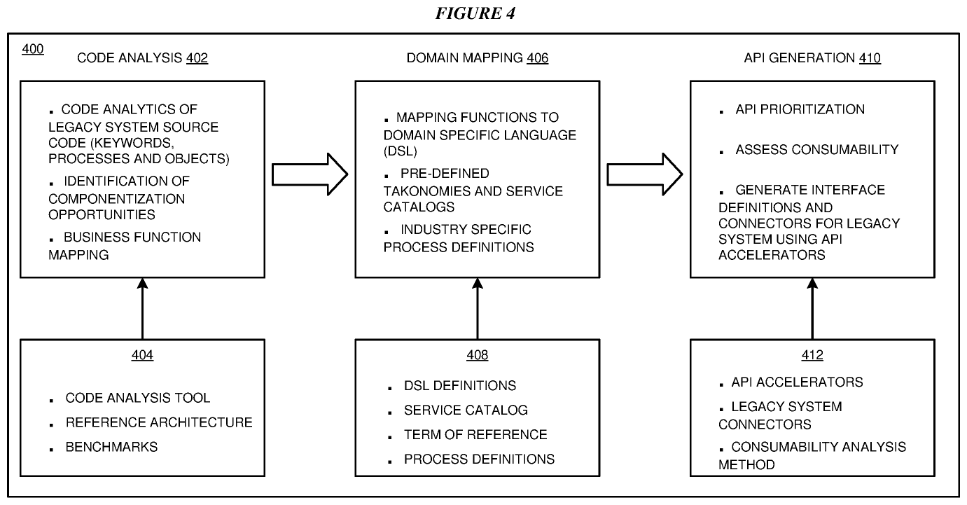

With reference to FIG. 4, this figure depicts a simplified example sequence 400 in accordance with an illustrative embodiment. In stage 402, application 105 performs code analytics of legacy system source code including identifying keyword, processes, and objects in the legacy system source code. In a particular embodiment, application 105 may further identify componentization opportunities in the legacy system source code and perform business function mapping of enterprise specific domain terms. In one or more embodiments, application 105 may utilize code analysis tools/information 404 including one or more of known code analysis tools, reference architecture information indicating a reference software architecture associated with the legacy system code, or benchmarks indicated expected performance of the legacy system source code to facilitate code analysis step 402.

In stage 406, application 105 performs domain mapping of the code analysis results including mapping functions within the legacy system source code to domain specific language (DSL). Application 105 further maps the DSL to terms of reference using natural language classification. In the embodiment, application 105 may use pre-defined taxonomies and service catalogs to facilitate mapping of DSL to terms of reference. In particular embodiments, a taxonomy may include a predefined hierarchical classification of entities of interest in an enterprise or organization using to classify documents and other assets. In particular embodiments, a service catalog is an organized and curated collection of business and information technology related services that can be performed by an enterprise.

In the embodiment, application 105 may further use industry specific process definitions to facilitate mapping of DSL to terms of reference. In one or more embodiments, application 105 may use DSL/ToR information 408 including DSL definitions, service catalogs, terms of reference (e.g., an IFW), and process definitions (e.g., Business Process Model and Notation (BPMN) standard information).

In stage 410, application 105 performs API generation to identify API candidates from the terms of reference, map the API candidates to portions of source code, identify patterns in the source code, determine cohesiveness and relevance of the identified patterns, and componentize the source code based upon the determined cohesiveness and relevance based upon a pattern model. In the embodiment, application 105 further maps the source code components to one or more API. In particular embodiments, the application 105 may further prioritize APIs, assess consumability of the APIs, and/or generate interface definitions and connectors for legacy system using one or more API accelerators. In particular embodiments, an API accelerator is a software application that accelerates development of an API by the including a set of pre-defined configuration files to facilitate API development.

In an embodiment, application 105 utilizes a cognitive model with supervised machine learning to discover the patterns in the legacy system source code, componentize the legacy system source code, and map the source code components to API as further described herein. In an embodiment, application 105 receives the code analysis output, related DSL, and available terms of reference which provide API candidates. In the embodiment, application 105 applies natural language classification to establish a mapping between DSL and terms of reference.

In an embodiment, a procedure is performed for defining discoverable patterns in a codebase such as legacy system source code. Defining a variable T={t₁, t₂, . . . , tₖ} to be a set of k terms t₁ . . . tₖ identified in the codebase, each code or code set may be identified as a document. A set of documents can then be established to be used as a training dataset for the cognitive model. A variable D is defined as a training set of documents which include a set of positive documents, D+, and a set of negative documents D″. In various embodiments, a set of terms is referred to a tCollection. TCount tc(d,t) is defined as the number of occurrences of term t in a given document d.

A set of pairs:

P={(tc)|tεT, f=tc(t,d)>0} (Equation 1)

where P is referred to as a pattern.

A pattern is uniquely determined by its tCollection as follows:

Let, tCollection(P)={t|(t,f)εP} (Equation 2)

The tCollection(Wi) of pattern P can be represented in a normal form wᵢ as:

$$w i = \frac{fi}{{\sum }_{j = 1}^{r} fi} for all i \leq r and i \geq 1 \qquad ( Equation 3 )$$

At the end of the foregoing step, application 105 begins identifying patterns in the codebase, DSL, and BPM. An example of a pattern includes the use of a Create Account function in a codebase represented by “+cr_act” pattern.

In the embodiment, application 105 performs componentization for the training dataset. In the embodiment, a cohesiveness parameter, cohesive(P), is used to describe the extent or frequency to which a pattern P is discussed in the training dataset with the assumption that the greater the cohesiveness, the more importance of the pattern.

Letting a componentization possibility be represented by O, O includes a set of patterns O={P₁, . . . , Pₙ}. The relationship between patterns are then processed by application 105 using the following rules:

if P₁ is a subset of P₂, then a “part-of” relationship exists between the two patterns P₁ and P₂;

if P₁∩P₂, then an intersect relationship exists between P₁ and P₂;

if P₁=P₂, then an “is-a” relationship exists between P₁ and P₂, and the two patterns P₁ and P₂ should be composed to generate new patterns.

P₁⊕P₂. cohesive (P₁⊕P₂)=cohesive (P₁)+cohesive (P₂)

where ⊕ is a composition operator.

The cohesive parameter can be normalized by:

Cohesive: O[0,1], such that

$$cohesive ( P ) = \frac{cohesive ( P )}{{\sum }_{Pj ɛ 0} cohesive ( Pj )}$$

In the embodiment, application 105 develops a learning dataset using hierarchical functioning. Considering a term T to consist of a set of clusters, ⊖, where each cluster in ⊖ is represented as a term:

⊖⊆T is called the set of primitive keywords.

Here, the hierarchical discoveries in ⊖ lead to correlation from O to M using a mapping function β which satisfies:

β:O→2^{⊕X[0,1]}−{0}

β(P)={(t1,w1),(t2,w2), . . . ,(tr,wr)}⊖⊆[0,1]

where β(P) is normal form with the dimensionality of Equation 3.

Training can be generalized as specificity and exhaustivity intent. Specificity (spe) describes the extent of the pattern whereas exhaustivity (exh) describes a different extent of the searching pattern. Employing Dempster-Shafer (D-S) theory, the numerical functions for measuring specificity and exhaustivity are:

$$\begin{matrix}spe ( A ) = {\sum }_{p ∈ O , w ( P ) ⊆ A}^{{2}^{⊖} \to [ 0 , 1 ]} cohesive ( P ) & ( Equation 7 ) \\ exh ( A ) = {\sum }_{p ∈ O , w ( P ) ⋂ A \neq 0}^{{2}^{⊖} \to [ 0 , 1 ]} cohesive ( P ) & ( Equation 8 )\end{matrix}$$

The specificity of pattern P is expressed by all of its sub-patterns and its exhaustivity is expressed by all patterns that overlap with it.

A probability function from a given set)<cohesive, is:

Pr(t)=Σ_{PεO,(t,w)εβ(P)}cohesive(P)X w|∀tεT (Equation 9)

With the maximum of the function for Equation 9 applied for Equation 6, the relevance of the pattern is defined as:

$$\begin{matrix}{Relevance}_{spe} ( {P}_{i} ) = spe ( {P}_{i} ) {\sum }_{t ɛ {P}_{i}} P r ( t ) & ( Equation 10 ) \\ {Relevance}_{exh} ( {P}_{i} ) = exh ( {P}_{i} ) {\sum }_{t ɛ {P}_{i}} P r ( t ) & ( Equation 11 )\end{matrix}$$

At the end of the above steps, a cohesive set of terms of reference, business activity and codebase are linked together to provide a key business function.

In a code text or functionality block, the frequent sequential patterns are more important. One or more embodiments adapt a Pattern Taxonomy Model (PTM) to distinguish mapping intent by analyzing learning feedback to derive rich semantic information underlying an object. In particular embodiments, feedback is obtained implicitly. In one or more embodiments, a pattern taxonomy is a tree-like structure that illustrates relationships between closed patterns extracted from a collection.

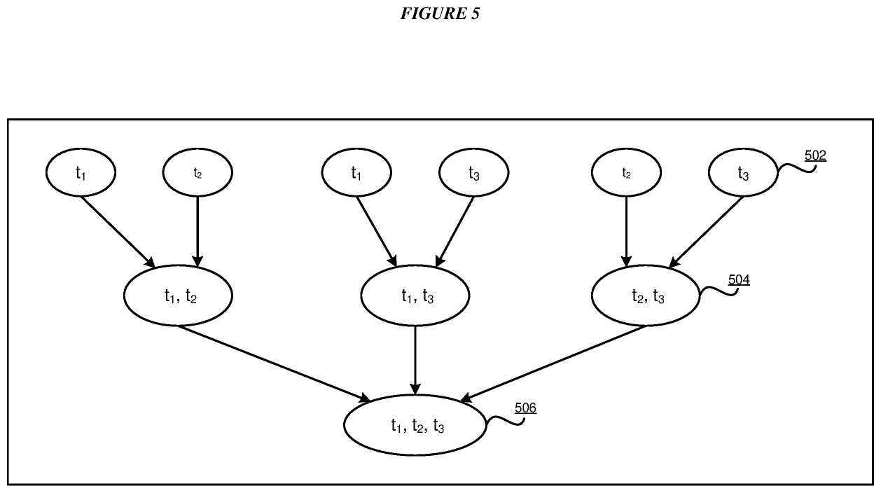

With reference to FIG. 5, this figure depicts an example pattern taxonomy tree-like structure 500 in accordance with an illustrative embodiment. Structure 500 includes a first tree level 502, a second tree level 504, and a third tree level 506. The arrows in FIG. 5 indicate a subsequence relationship between patterns. The pattern <t1,t2> is a subsequence of pattern <t1,t2,t3>. Pattern <t2> is a subsequence of pattern <t2,t3>. The root of the tree in the third tree level 506 represents one of the largest patterns. Once structure 500 is constructed, the relationship between patterns can be quantified. From constructed the pattern taxonomy, application 105 creates validated patterns of complete mapping from a business function to the source code sections of the legacy system code.

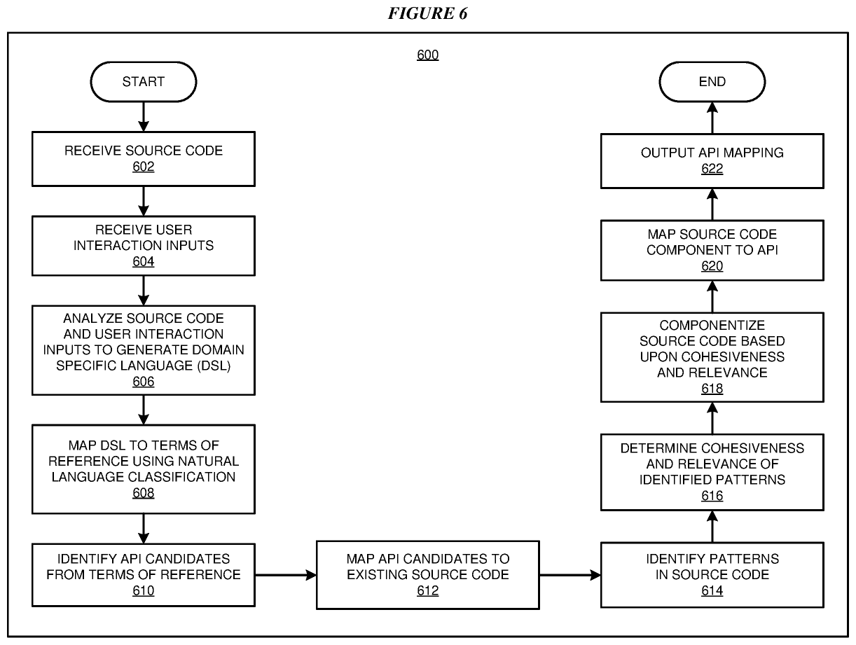

With reference to FIG. 6, this figure depicts a flowchart of an example process 600 for cognitive application programming interface discovery from legacy system code in accordance with an illustrative embodiment. In block 602, application 105 receives source code associated with a legacy system. In block 604, application 105 receives user interaction inputs including information associated with user interaction with an application associated with the source code that may be indicative of a function of a portion of the source code.

In block 606, application 105 analyzes the source code and user interaction inputs to generate domain specific language (DSL) represented within the source code. In block 608, application 105 maps the DSL is mapped to terms of reference using natural language classification or another suitable artificial intelligence/machine learning process. In block 610, application 105 identifies API candidates from the terms of reference.

In block 612, application 105 maps the identified API candidates to portions of the existing source code. In the embodiment, application 105 uses the identified API candidates to identify specific portions of code which include terms indicative of a function associated with the identified API. In block 614, application 105 identifies one or more patterns between terms in the portions of source code using a pattern discovery model. In particular embodiments, the terms include one or more of program code logic, program variables, or DSLs within the source code. In particular embodiments, the pattern discovery model is a cognitive model.

In block 616, application 105 determines a cohesiveness parameter and relevance parameter between a set of patterns including one or more of the identified patterns. In a particular embodiment, the cohesiveness parameter is indicative of a frequency to which the set of patterns are found in training data. In a particular embodiment, the relevance parameter is indicative of a relevance of the set of patterns for performing a function associated with the API candidate.

In block 618, application 105 componentize the source code based upon the cohesiveness parameter and relevance parameter by identifying portions of the source code that represent separate functional components (e.g., a portion of the source code that is used to perform a particular function or calculation on input data). In particular embodiments, application 105 componentizes the source code using a machine learning procedure.

In block 620, application 105 maps the source code components to an enabling API. In block 622, application 105 outputs the API mapping. Process 600 then ends.

Thus, a computer implemented method, system or apparatus, and computer program product are provided in the illustrative embodiments for cognitive application programming interface discovery from legacy system code and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for application programming interface discovery, the method comprising:
receiving source code associated with a computer system;
analyzing the source code to generate domain specific language (DSL) represented within the source code;
mapping the DSL to terms of reference associated with an enterprise;
identifying at least one candidate application programming interface (API) based upon the terms of reference;
mapping the at last one candidate API to a portion of the source code;
executing a cognitive model, wherein the cognitive model is configured with a supervised machine learning function and wherein the executing causes the cognitive model to perform operations comprising (i) identifying one or more patterns between terms in the portion of source code, (ii) identifying a source code component of the source code representative of a separate functional component within the source code based upon the one or more patterns, and (iii) mapping the source code component to an enabling API.

2. The method of claim 1, further comprising:
receiving a user interaction input including information associated with user interaction with an application associated with the source code indicative of the function of the source code, the DSL being generated based upon the source code and user interaction input.

3. The method of claim 1, wherein the DSL is mapped to the terms of reference using natural language processing.

4. The method of claim 1, wherein mapping the at last one candidate API to the portion of the source code includes identify the portion of the source code as indicative of a function associated with the at least one candidate API.

5. The method of claim 1, wherein the terms include one or more of program code logic within the source code, a program variable within the source code, or a DSL object within the source code.

6. The method of claim 1, wherein the one or more patterns between terms are identified using a pattern discovery model.

7. The method of claim 6, wherein the pattern discovery model includes a cognitive model.

8. The method of claim 1, further comprising:
determining a cohesiveness parameter between a set of the one or more patterns; and
determining a relevance parameter between the set of the one or more patterns.

9. The method of claim 8, wherein identifying the source code component is based upon the cohesiveness parameter and the relevance parameter.

10. The method of claim 8, wherein the cohesiveness parameter is indicative of a frequency of the set of patterns being found in training data.

11. The method of claim 8, wherein the relevance parameter is indicative of a relevance of the set of patterns for performing a function associated with the API candidate.

12. A computer usable program product comprising one or more computer-readable storage devices, and program instructions stored on at least one of the one or more storage devices, the stored program instructions comprising:
program instructions to receive source code associated with a computer system;
program instructions to analyze the source code to generate domain specific language (DSL) represented within the source code;
program instructions to map the DSL to terms of reference associated with an enterprise;
program instructions to identify at least one candidate application programming interface (API) based upon the terms of reference;
program instructions to map the at last one candidate API to a portion of the source code;
program instructions to execute a cognitive model, wherein the cognitive model is configured with a supervised machine learning function and wherein the program instructions cause the cognitive model to perform operations comprising (i) identifying one or more patterns between terms in the portion of source code, (ii) identifying a source code component of the source code representative of a separate functional component within the source code based upon the one or more patterns, and (iii) mapping the source code component to an enabling API.

13. The computer usable program product of claim 12, further comprising:
program instructions to receiving a user interaction input including information associated with user interaction with an application associated with the source code indicative of the function of the source code, the DSL being generated based upon the source code and user interaction input.

14. The computer usable program product of claim 12, wherein the DSL is mapped to the terms of reference using natural language processing.

15. The computer usable program product of claim 12, wherein mapping the at last one candidate API to the portion of the source code includes identify the portion of the source code as indicative of a function associated with the at least one candidate API.

16. The computer usable program product of claim 12, wherein the terms include one or more of program code logic within the source code, a program variable within the source code, or a DSL object within the source code.

17. The computer usable program product of claim 12, wherein the one or more patterns between terms are identified using a pattern discovery model.

18. The computer usable program product of claim 12, wherein a computer usable code is stored in a computer readable storage device in a data processing system, and wherein the computer usable code is transferred over a network from a remote data processing system.

19. The computer usable program product of claim 12, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to receive source code associated with a computer system;
program instructions to analyze the source code to generate domain specific language (DSL) represented within the source code;
program instructions to map the DSL to terms of reference associated with an enterprise;
program instructions to identify at least one candidate application programming interface (API) based upon the terms of reference;
program instructions to map the at last one candidate API to a portion of the source code;
program instructions to execute a cognitive model, wherein the cognitive model is configured with a supervised machine learning function and wherein the program instructions cause the cognitive model to perform operations comprising (i) identifying one or more patterns between terms in the portion of source code, (ii) identifying a source code component of the source code representative of a separate functional component within the source code based upon the one or more patterns, (iii) mapping the source code component to an enabling API.
